(19) United States
(12) Patent Application Publication
(10) Pub. No.: US 2011/0316267 A1
(43) Pub. Date: Dec. 29, 2011

(54) DNA ENABLED CERTIFICATE

(76) Inventor: Larry FUSON, LaPorte City, IA (US)

(21) Appl. No.: 13/166,965

(22) Filed: Jun. 23, 2011

Related U.S. Application Data
(60) Provisional application No. 61/357,537, filed on Jun. 23, 2010.

(51) Int. Cl. B42D 15/10

(52) U.S. Cl. 283/78

(57) ABSTRACT

A DNA birth certificate has a DNA sample portion to securely hold a biological sample for use in positively identifying an individual. It can be used to keep track of babies to prevent hospital mix-ups or in child stealing cases. Additionally, the certificate can be an ID or even a driver's license. The DNA sample portion holds one or more containers that allow the user to place a biological sample such as a hair or nail clipping within to provide the DNA if needed. In another embodiment, a DNA sample storage card known as an FTA© CLASSIC CARD©, a patented DNA storage card, is used to store the DNA information. Other biometrics such as finger or footprints, hair samples, nail clippings, etc. may also be stored on the DNA certificate.

### CROSS REFERENCE TO RELATED APPLICATIONS

This application claims priority and herein incorporates by reference U.S. provisional patent application 61/357,537 filed Jun. 23, 2010.

### BACKGROUND OF THE INVENTION

Keeping track of a person's identity is becoming more important in today's society. However, even in historical times, being able to prove parentage was sometimes an issue as evidenced by the famous story of king Solomon judging between two woman both claiming to be the mother. The wise king was able to discern the truth, but short of being the wisest human, science has provided us with many tools to determine identity.

Even with many safeguards and protocols in place, it is not unknown to have a hospital mix up babies and parents are given the wrong children. Science has provided us with tools such as blood types to try to determine those that could not be the parents, it has only recently become possible to show with great certainty parentage. DNA testing is becoming more common and is often employed forensically in criminal cases.

There is a need for a positive identification instrument that relies on the science of DNA to prove identity that is inexpensive, easy to use and promotes long term viability of the DNA sample.

### SUMMARY OF THE INVENTION

A DNA birth certificate has a DNA sample portion to securely hold a biological sample for use in positively identifying an individual. It can be used to keep track of babies to prevent hospital mix-ups or in child stealing cases. Additionally, the certificate can be an ID or even a driver's license. The DNA sample portion holds one or more containers that allow the user to place a biological sample such as a hair or nail clipping within to provide the DNA if needed. In another embodiment, a DNA sample storage card known as an FTA© CLASSIC CARD©, a patented DNA storage card, is used to store the DNA information. Other biometrics such as finger or footprints, hair samples, nail clippings, etc. may also be stored on the DNA certificate.

Other features and advantages of the instant invention will become apparent from the following description of the invention which refers to the accompanying drawings.

### BRIEF DESCRIPTION OF THE DRAWINGS

FIG. 1 is an illustration of a DNA enabled birth certificate according to an embodiment of the invention.

FIG. 2 is an illustration of the DNA enabled birth certificate shown in FIG. 1 with an alternative DNA enabled storage system and biometric.

FIG. 3 is an illustration of the DNA enabled birth certificate shown in FIG. 1 with another alternative DNA storage system.

FIG. 4 is an illustration of a DNA enabled identity certificate according to an embodiment of the invention.

FIG. 5 is an illustration of a DNA enabled identification card according to an embodiment of the invention.

FIG. 6 is an illustration of a DNA enabled identification card attached to a chain according to an embodiment of the invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

Although the instant invention has been described in relation to particular embodiments thereof, many other variations and modifications and other uses will become apparent to those skilled in the art.

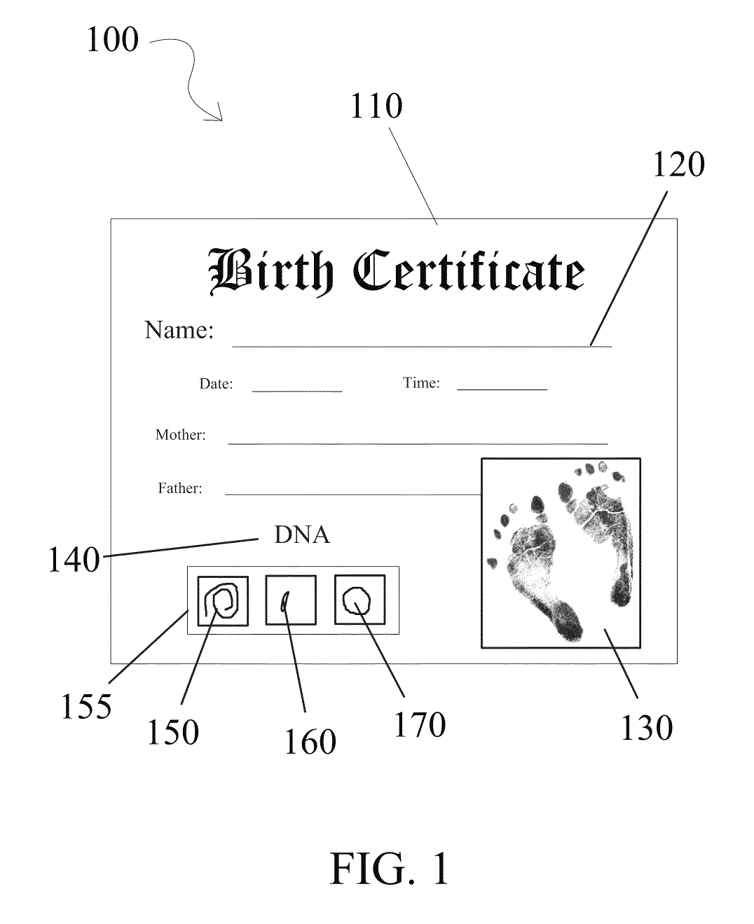

Referring to FIG. 1, a DNA birth certificate 100 is shown having a certificate 110 with printed information 120 such as name, date and time of birth along with parental information. Of course other information may be included or excluded since the information shown is merely representative of common kinds of information found on birth certificates. In addition to written information 120, graphical information such as footprints 130 may be applied.

A DNA sample area 140 is provided to allow a user to secure DNA containing samples to DNA birth certificate 100. Many kinds of biologically active samples may be used such as hair 150, nail clipping 160 and blood 170. These samples are sealed within a laminated section 155 to preserve the samples. Of course any biologically active sample may be used as long as it is practical to fit within the area provided 155 and contains intact DNA.

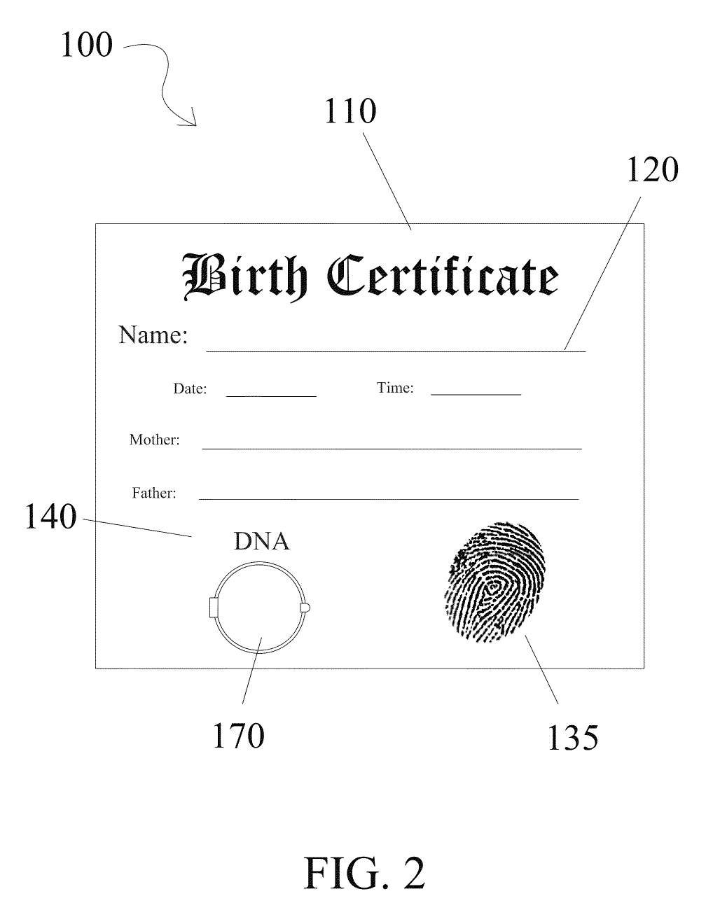

Now referring to FIG. 2, DNA birth certificate 100 is shown having a fingerprint 135 and a DNA sample container 170. DNA sample container 170 is attached to DNA birth certificate 100 and opens to allow the user to place a DNA containing biological sample within and then seal shut. Container 170 may be round as shown or any other suitable shape. Container 170 is relatively thin so that is does not stick out very far from the surface of DNA birth certificate 100, but again, other shapes could be used. Again, as discussed above, although fingerprint 135 is shown, other biometric identifiers could be used.

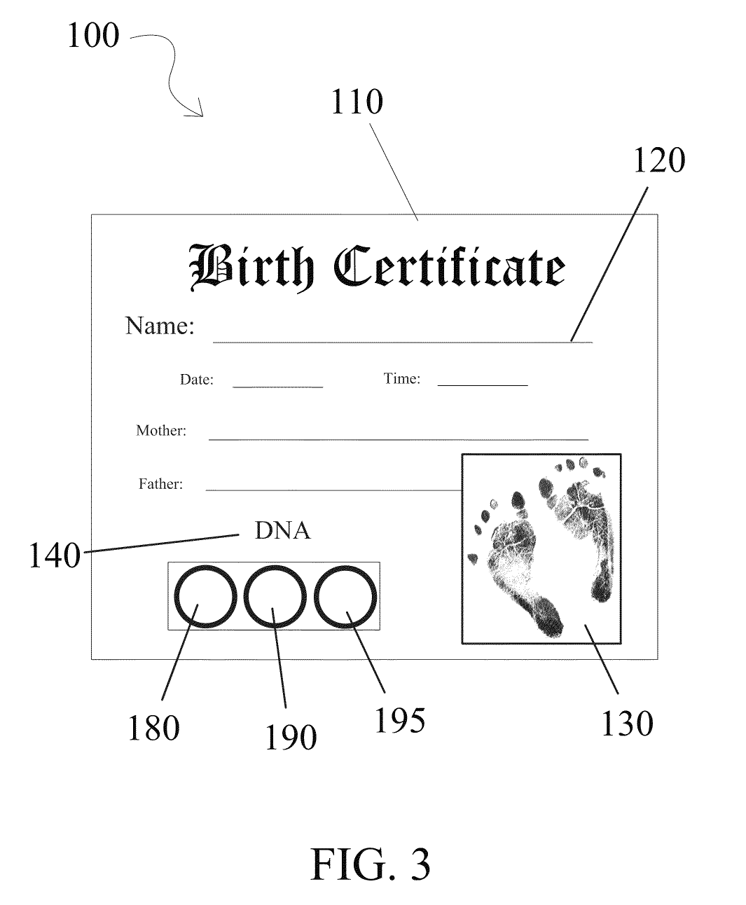

Referring now to FIG. 3, DNA birth certificate 100 is shown having a special DNA receiving section 140 with three DNA storage areas 180, 190 and 195 respectively. The material shown is known as WHATMAN© FTA© Classic Card© and is the subject of several patents. It allows for dry storage of DNA samples for years at room temperature without degrading. Of course other kinds of DNA storage materials may used as long as they preserve the DNA without significant degradation.

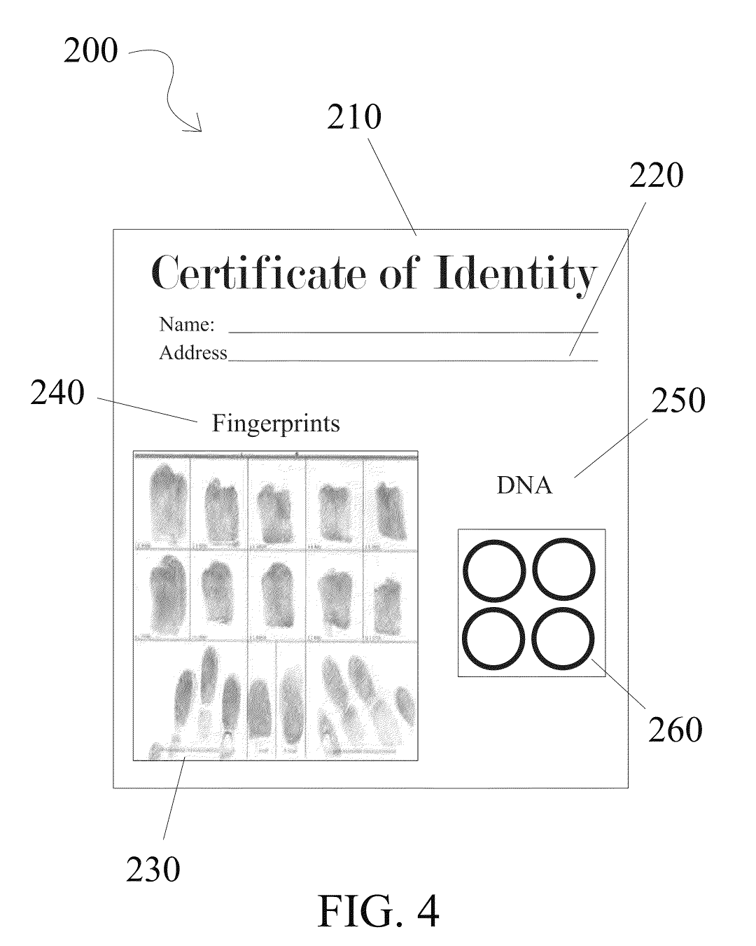

Referring now to FIG. 4, a DNA certificate of identity 200 is shown having a certificate 210 with written identification information 220 thereon. Although only name and address is shown, other kinds of identifying information may be provided such as age, weight, height, eye color, etc. to further help identify a person.

A biometric sample area 240 is shown having fingerprints 230. Again, other biometrics may be used such as physical samples, etc. In addition to fingerprints 230, a DNA sample area 250 is provided to store DNA samples on a FTA© CLASSIC CARD© 260. Again, other DNA preserving devices may be used as discussed above.

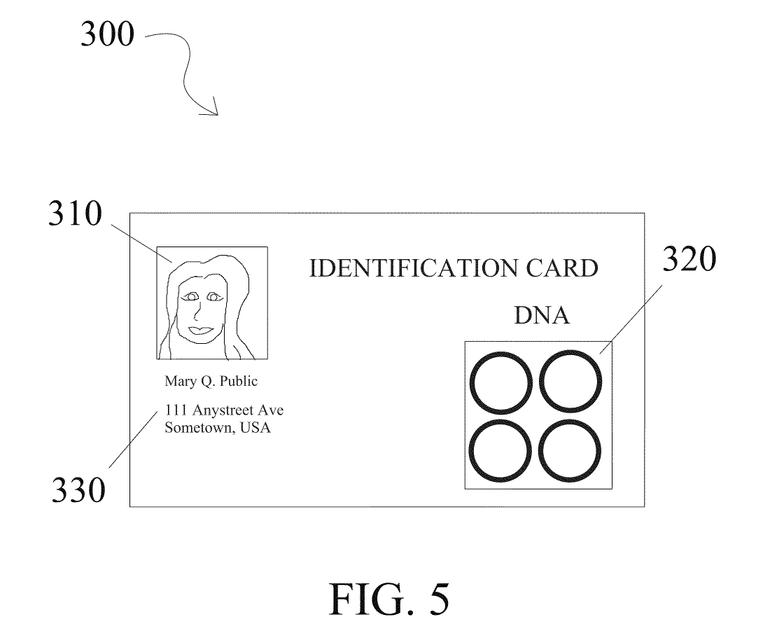

Now referring to FIG. 5, a DNA identification card 300 is shown having printed information 330 such as name and address, etc. In the embodiment shown, a picture 310 is provided to help identify a person. A DNA sample section 320 is provided to store DNA material that can be used to positively identify a person. Again, as discussed above, any suitable DNA storage method may be used to provide stable storage of DNA sample. DNA identification card 300 may be a state driver's license, sheriff's ID, etc.

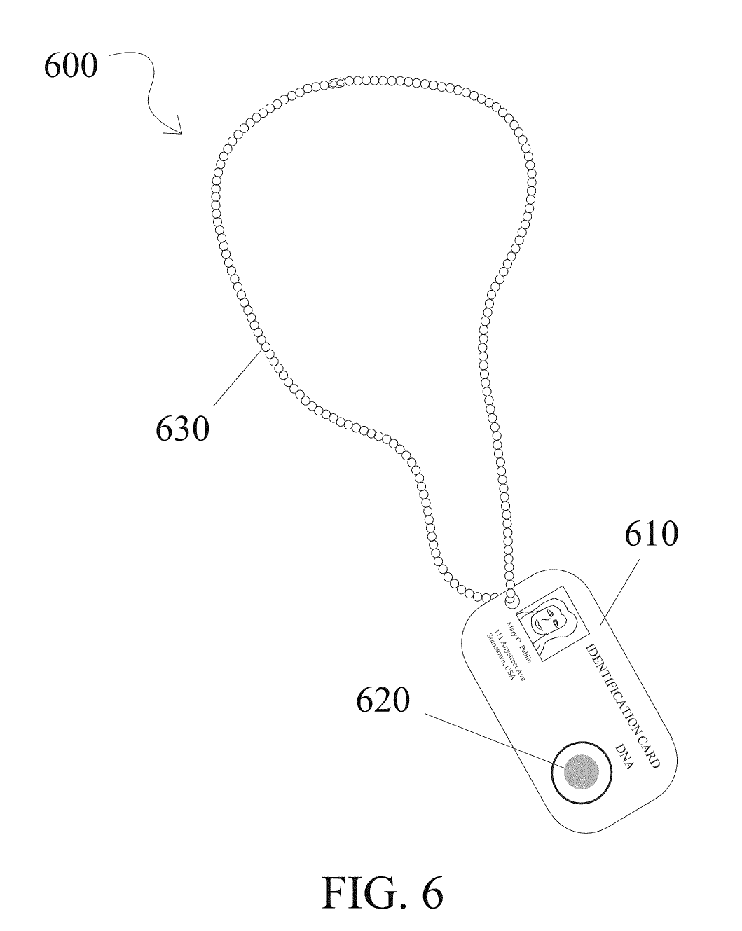

Referring now to FIG. 6, a DNA identification card 600 is shown having a chain or necklace portion 630 with an ID card 610. ID card 610 has a DNA preserving portion 620 as discussed above. Medical information may also be stored on ID card 610.

Although the instant invention has been described in relation to particular embodiments thereof, many other variations and modifications and other uses will become apparent to those skilled in the art.

What is claimed is:

1. A DNA enabled certificate comprising:
an informational section adapted to record and display information concerning an identity of a user; and
a sample section adapted to retain a biological sample of said user.

2. The DNA enabled certificate according to claim 1 wherein said biological sample is a DNA sample.

3. The DNA enabled certificate according to claim 2 wherein said DNA sample is a blood sample from said user.

4. The DNA enabled certificate according to claim 2 wherein said DNA sample is a cheek swapping.

5. The DNA enabled certificate according to claim 1 wherein said information section is a birth record.

6. The DNA enabled certificate according to claim 2 further comprising an additional biometric identification section.

7. The DNA enabled certificate according to claim 6 wherein said additional biometric identification section is a fingerprint.

8. The DNA enabled certificate according to claim 6 wherein said additional biometric identification section is a fingernail clipping.

9. The DNA enabled certificate according to claim 6 wherein said additional biometric identification section is a hair sample.

10. The DNA enabled certificate according to claim 1 wherein said sample section comprises a sample container.

11. The DNA enabled certificate according to claim 10 wherein said sample container is adapted to seal said biological sample therein.

12. A DNA enabled certificate comprising:
an informational section adapted to display information concerning an identity of a user; and
a sample section having a means for retaining and preserving a biological sample of said user.

13. The DNA enabled certificate according to claim 12 wherein said biological sample is a DNA sample.

14. The DNA enabled certificate according to claim 13 wherein said means for retaining and preserving a biological sample is a sample container.

15. The DNA enabled certificate according to claim 13 wherein said means for retaining and preserving a biological sample is a FTA® sample card.

16. The DNA enabled certificate according to claim 12 wherein said certificate is a card.

17. The DNA enabled certificate according to claim 12 further comprising a means for wearing said DNA enabled certificate.

18. The DNA enabled certificate according to claim 17 wherein said means for wearing said DNA enabled certificate is a chain.
